(19) United States
(12) Patent Application Publication
(10) Pub. No.: US 2025/0151707 A1
(43) Pub. Date: May 15, 2025

(54) DUAL-BEARING REEL

(71) Applicant: Shimano Inc., Osaka (JP)

(72) Inventor: Kohei NAKAMURA, Osaka (JP)

(21) Appl. No.: 18/923,209

(22) Filed: Oct. 22, 2024

(30) Foreign Application Priority Data
Nov. 14, 2023 (JP) 2023-193802

(51) Int. Cl. A01K 89/015; B65H 75/44

(52) U.S. Cl. CPC A01K 89/01916; A01K 89/0188; B65H 75/4407; B65H 2403/72; B65H 2701/355

(57) ABSTRACT

A dual-bearing reel includes a reel body, a handle, a spool shaft, a spool, a clutch mechanism, and a level winding mechanism. The clutch mechanism switches between a clutch-on state and a clutch-off state. The level winding mechanism has a line guide unit, a moving part, and a switching mechanism. The line guide unit moves along an axial direction of the spool shaft. The moving part moves along the axial direction of the spool shaft. The switching mechanism switches between a coupled state in which the line guide unit and the moving part are coupled, and a decoupled state in which the line guide unit and the moving part are decoupled, in accordance with the switching between the on state and the off state.

### CROSS-REFERENCE TO RELATED APPLICATIONS

This application claims priority to Japanese Patent Application No. 2023-193802, filed on Nov. 14, 2023. The entire disclosure of Japanese Patent Application No. 2023-193802 are hereby incorporated by reference.

### BACKGROUND

### Technical Field

The present disclosure relates to a dual-bearing reel.

### Background Information

A conventional dual-bearing reel can comprise a reel body, a spool shaft, a spool, a clutch mechanism, and a level winding mechanism (refer to Japanese Laid Open Patent Application No. 2019-30252). The handle is configured to rotate relative to the reel body. The spool shaft is supported by the reel body so as to be rotatable. The spool rotates together with the spool shaft. A fishing line is wound onto the spool. Specifically, the fishing line is wound around a bobbin trunk of the spool, between a pair of flanges of the spool.

The level winding mechanism can be used to evenly wind the fishing line around the bobbin trunk of the spool. The level winding mechanism includes a worm shaft that rotates relative to the reel body in conjunction with the rotation of the handle, an engagement member that engages the worm shaft, and a line guide unit. The line guide unit moves back and forth along the worm shaft, in conjunction with the rotation of the worm shaft, via the engagement member.

### SUMMARY

In a conventional dual-bearing reel, when a fishing line is released from the spool, the line guide unit is disposed at a prescribed position with respect to the worm shaft via the engagement member. In this state, the fishing line passes through the line guide unit and is guided forward, while moving back and forth on the spool in an axial direction of the spool shaft.

For example, when the line guide unit is disposed on a left flange side of the spool in front of the bobbin trunk, fishing line that is wound on the left flange side will be smoothly released forward from the line guide unit. On the other hand, fishing line wound on a right flange side extends at an angle toward the line guide unit on the left flange side, which increases sliding resistance with respect to the line guide unit when passing through the line guide unit. Therefore, it has been determined that it can become difficult for fishing line on the right flange side to be released in a forward direction (i.e., when casting) from the line guide unit. That is, in a conventional dual-bearing reel, there is the problem that the flight distance of the tackle will decrease or that backlash will occur at the time of line release. In addition, when the pull of a fish that has been caught is strong and the fishing line is released due to slippage of a friction member of a drag mechanism, there is the risk that resistance will increase at the time of line release, resulting in problems such as line breakage.

An object of the present disclosure is to provide a dual-bearing reel that can reduce the resistance that acts on the fishing line at the time of line release.

In accordance with a first aspect of the present disclosure, a dual-bearing reel comprises a reel body, a handle, a spool shaft, a spool, a clutch mechanism, and a level winding mechanism. The handle is configured to rotate relative to the reel body. The spool shaft is supported by the reel body so as to be rotatable. The spool rotates together with the spool shaft. A fishing line is wound onto the spool.

The clutch mechanism switches between an on state in which rotation of the handle is transmitted to the spool, and an off state in which the transmission of the rotation of the handle to the spool is cut off. The level winding mechanism is used for evenly winding the fishing line onto the spool.

The level winding mechanism has a line guide unit, a moving part, and a switching mechanism. The line guide unit guides the fishing line. The line guide unit moves along the axial direction of the spool shaft. The moving part moves along the axial direction of the spool shaft. The switching mechanism switches between a coupled state in which the line guide unit and the moving part are coupled, and a decoupled state in which the line guide unit and the moving part are decoupled, in accordance with the switching between the on state and the off state.

In the dual-bearing reel according to the first aspect of the present disclosure, the switching mechanism switches between the coupled state and the decoupled state in accordance with the switching between the on state and the off state. For example, when the rotation transmission state of the handle and the spool is in the on state, the switching mechanism couples the line guide unit and the moving part. The fishing line can be evenly wound onto the spool by rotating the handle in this state,

On the other hand, when the rotation transmission state of the handle and the spool is in the off state, the switching mechanism decouples the line guide unit and the moving part. When the fishing line is released in this state, the fishing line is guided forward by the line guide unit, while the line guide unit moves along the axial direction of the spool shaft. In this manner, in this dual-bearing reel, it is possible to reduce the resistance that acts on the fishing line at the time of line release.

In accordance with a second aspect of the present disclosure, the dual-bearing reel according to the first aspect can be configured such that the level winding mechanism further includes a worm shaft that has a spiral groove and rotates relative to the reel body in conjunction with the rotation of the spool, and an engagement member that engages the spiral groove. The moving part moves along the axial direction of the spool shaft in conjunction with the rotation of the worm shaft, via the engagement member.

In the dual-bearing reel according to the second aspect of the present disclosure, when the rotation transmission state of the handle and the spool is in the on state, the switching mechanism couples the line guide unit and the moving part. By rotating the handle in this state, the line guide unit and the moving part move along the axial direction of the spool shaft in conjunction with the rotation of the worm shaft, via the engagement member. In this manner, the fishing line can be evenly wound onto the spool even when using the switching mechanism.

In accordance with a third aspect of the present disclosure, the dual-bearing reel according to the second aspect can be configured such that the level winding mechanism further comprises a guide member. The guide member guides the moving part in the axial direction of the worm shaft, and rotates in the circumferential direction of the worm shaft together with the moving part. The switching mechanism rotates the moving part in the circumferential direction of the worm shaft to switch between the coupled state and the decoupled state.

In the dual-bearing reel according to the third aspect of the present disclosure, the moving part can be rotated in the circumferential direction of the worm shaft to easily switch the state of the line guide unit and the moving part between the coupled state and the decoupled state.

In accordance with a fourth aspect of the present disclosure, the dual-bearing reel according to any one of the first to the third aspects can be configured such that the switching mechanism has a first magnet provided on one of either the moving part or the line guide unit, and a magnetic body that is provided on the other element, i.e., either the line guide unit or the moving part, and that faces the first magnet.

In the dual-bearing reel according to the fourth aspect of the present disclosure, it is possible the easily couple the moving part with the line guide unit using the magnetic force that acts between the first magnet and the magnetic body, and to easily decouple the moving part and the line guide unit.

In accordance with a fifth aspect of the present disclosure, the dual-bearing reel according to the fourth aspect can be configured such that the magnetic body includes a second magnet that attracts, and is attracted to, the first magnet due to magnetic force.

In the dual-bearing reel according to the fourth aspect of the present disclosure, it is possible the easily couple the moving part with the line guide unit using the magnetic force that acts between the first magnet and the second magnet, and to easily decouple the moving part and the line guide unit.

In the present disclosure, it is possible to reduce the resistance that acts on the fishing line at the time of line release in a dual-bearing reel.

### BRIEF DESCRIPTION OF THE DRAWINGS

FIG. 1 is a front view of a dual-bearing reel.

FIG. 2 is a side view showing a clutch mechanism and a level winding mechanism.

FIG. 3 is a front view showing a state in which a front cover and a side cover have been removed from the dual-bearing reel.

FIG. 4 is a side view illustrating a configuration of the level winding mechanism.

FIG. 5 is a perspective view illustrating the configuration of the level winding mechanism.

FIG. 6 is a cross-sectional view taken along the section line VI of FIG. 4.

FIG. 7 is a side view illustrating an operation of the level winding mechanism.

FIG. 8 is a side view illustrating the operation of the level winding mechanism.

FIG. 9 is a front view illustrating the operation of the level winding mechanism.

FIG. 10 is a perspective view illustrating a modified example of the level winding mechanism.

FIG. 11 is a cross-sectional view illustrating a modified example of the level winding mechanism.

### DETAILED DESCRIPTION OF EMBODIMENTS

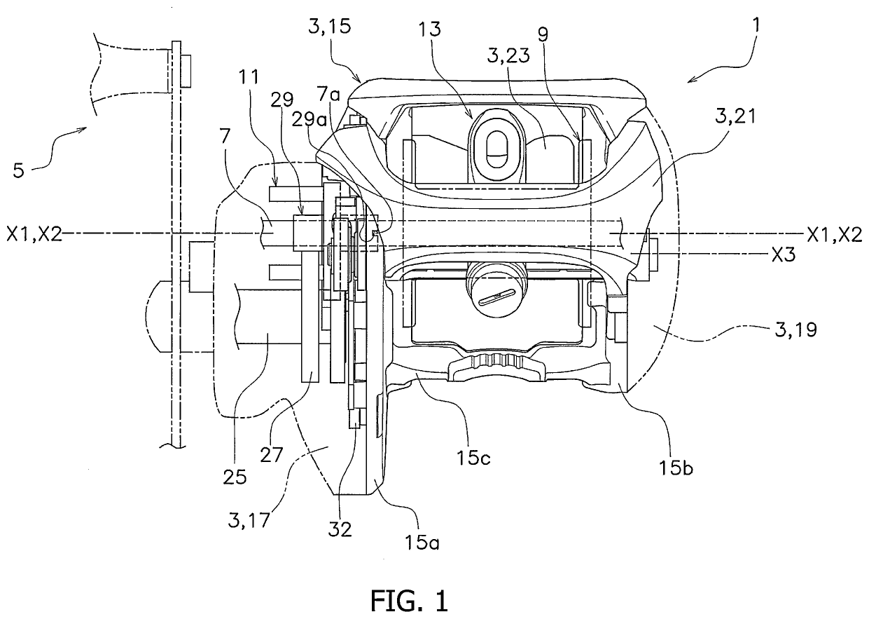

As shown in FIG. 1, a dual-bearing reel 1 according to one embodiment of the present disclosure comprises a reel body 3, a handle 5, a spool shaft 7, a spool 9, a clutch mechanism 11, and a level winding mechanism 13.

In the present embodiment, an axis X1 of the spool shaft 7 and a rotational axis X2 of the spool 9 are concentric. The direction in which the axis X1 of the spool shaft 7 extends and the direction in which the rotational axis X2 of the spool 9 extends, are defined as the axial direction of the spool shaft 7.

The direction away from the axis X1 of the spool shaft 7 and the direction away from the rotational axis X2 of the spool 9 are defined as the radial direction of the spool shaft 7. The direction around the axis X1 of the spool shaft 7 and the direction around the rotational axis X2 of the spool 9 are defined as the circumferential direction of the spool shaft 7.

When viewed from above the dual-bearing reel 1, the direction in which the fishing line is released (i.e., casting direction) is referred to as the front, and the direction opposite to the front is referred to as the back. In a state in which the dual-bearing reel 1 is mounted on the fishing rod, the direction approaching the fishing rod is referred to as down and the direction away from the fishing rod is referred to as up.

As shown in FIG. 1, the reel body 3 includes a frame 15, a first side cover 17, a second side cover 19, a front cover 21, and a clutch lever 23. The frame 15 includes a first side plate 15a, a second side plate 15b, and a connecting portion 15c.

The first side plate 15a and the second side plate 15b are arranged spaced apart from each other in the axial direction of the spool shaft 7. The connecting portion 15c connects the first side plate 15a and the second side plate 15b. The first side plate 15a, the second side plate 15b, and the connecting portion 15c are integrally formed. The first side cover 17 is attached to the first side plate 15a. The second side cover 19 is attached to the second side plate 15b.

The front cover 21 is attached to the first side plate 15a and the second side plate 15b. Specifically, the front cover 21 is attached to the first side plate 15a and the second side plate 15b in front of the spool 9. The clutch lever 23 is disposed between the first side plate 15a and the second side plate 15b. The clutch lever 23 is disposed between the first side plate 15a and the second side plate 15b behind the spool 9.

The handle 5 is configured to rotate with respect to the reel body 3. Specifically, the handle 5 is attached to a handle shaft 25 that is supported so as to be rotatable relative to the reel body 3. The handle shaft 25 is supported so as to be rotatable relative to the first side cover 17 and the first side plate 15a.

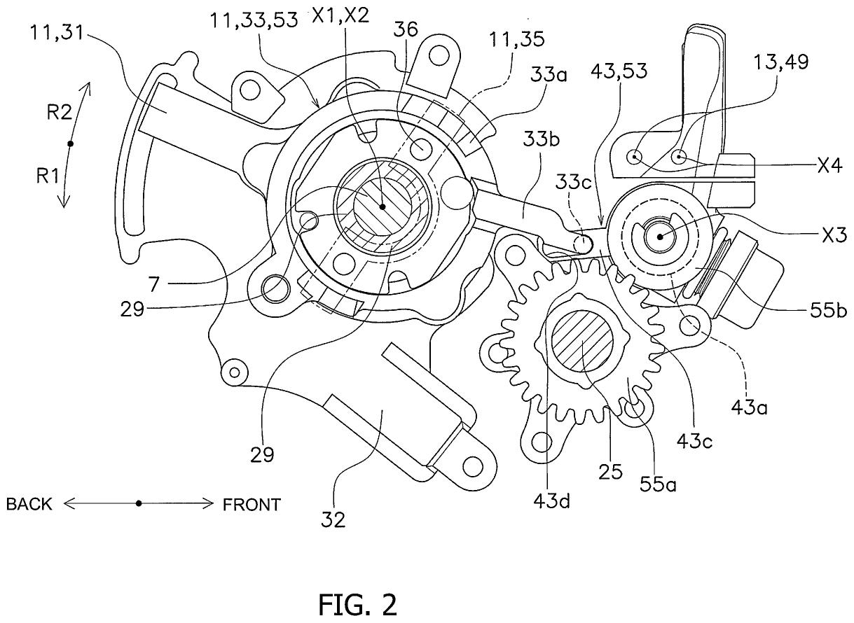

As shown in FIG. 1, a main gear 27 is provided on the handle shaft 25. A pinion gear 29 meshes with the main gear 27. As shown in FIGS. 1 and 2, the pinion gear 29 is disposed on an outer circumferential surface of the spool shaft 7 so as to rotate relative to the spool shaft 7 in the circumferential direction of the spool shaft 7, and to move in the axial direction of the spool shaft 7. As shown in FIG. 1, a pair of recesses 29a is provided at the end of the pinion gear 29. The pair of recesses 29a constitutes the clutch mechanism 11.

The spool shaft 7 is supported by the reel body 3 so as to be rotatable. The spool 9 is disposed radially outward of the spool shaft 7. A fishing line is wound onto the spool 9. The spool 9 is mounted onto the spool shaft 7 and rotates together with the spool shaft 7. A pair of protrusions 7a is provided on the spool shaft 7. The pair of protrusions 7a can constitute the clutch mechanism 11.

As shown in FIG. 1, the clutch mechanism 11 switches the rotation transmission state of the handle 5 and the spool 9 between an on state in which the rotation of the handle 5 is transmitted to the spool 9, and an off state in which the transmission of the rotation of the handle 5 to the spool 9 is cut off. Specifically, the clutch mechanism 11 moves the pinion gear 29 in the axial direction of the spool shaft 7 to switch the rotation transmission state of the handle 5 and the spool 9 between the on state and the off state. The mode by which the rotation transmission state of the handle 5 and the spool 9 is switched between the on and off states is essentially the same as that of the prior art. As shown in FIG. 2, the clutch mechanism 11 has a clutch plate 31, a clutch cam 33, a clutch yoke 35, the pair of recesses 29a of the pinion gear 29 (refer to FIG. 1), and the pair of protrusions 7a of the spool shaft 7 (refer to FIG. 1).

As shown in FIG. 2, a clutch lever 23 shown in FIG. 1 is attached to the clutch plate 31. The clutch plate 31 is attached to the first side plate 15a of the frame 15 so as to rotate in a first rotational direction R1 and a second rotational direction R2. Specifically, the clutch plate 31 is attached to the first side plate 15a of the frame 15 via a plate receiving member 32 so as to rotate in the first rotational direction R1 and the second rotational direction R2. The plate receiving member 32 is fixed to the first side plate 15a of the frame 15.

The clutch cam 33 is disposed so as to turn relative to the first side plate 15a of the frame 15. Specifically, the clutch cam 33 is attached to the clutch plate 31. The clutch cam 33 turns in the first rotational direction R1 and the second rotational direction R2 with respect to the first side plate 15a of the frame 15, in accordance with the rotation of the clutch plate 31.

As shown in FIG. 2, the clutch cam 33 is formed in an essentially annular shape. The clutch cam 33 has cam portions 33a and a first arm portion 33b. The cam portions 33a are arranged in the circumferential direction of the spool shaft 7. The cam portions 33a engage the clutch yoke 35 and move the clutch yoke 35 in the axial direction of the spool shaft 7.

The first arm portion 33b extends forward from the cam portions 33a. Specifically, the first arm portion 33b extends toward a second arm portion 43c of a guide member 43, described further below. A protrusion 33c that extends in the axial direction of the spool shaft 7 is provided on the first arm portion 33b. The protrusion 33c engages a slot 43d (longitudinally extending hole) of the second arm portion 43c of the guide member 43.

As shown in FIG. 2, the clutch yoke 35 engages with the cam portions 33a of the clutch cam 33 as well as with the pinion gear 29. The clutch yoke 35 moves in the axial direction of the spool shaft 7 as a result of the rotation of the clutch cam 33. The clutch yoke 35 is guided in the axial direction of the spool shaft 7 by a support member 36.

In FIG. 2, the rotation transmission state of the handle 5 and the spool 9 is the on state. When the clutch lever 23 is pressed downward in this state, the clutch plate 31 and the clutch cam 33 can rotate in the first rotational direction R1. As a result, the clutch yoke 35 moves in the axial direction away from the first side plate 15a of the frame 15 of the clutch cam 33.

In this case, the pinion gear 29 moves in the axial direction away from the spool 9, in conjunction with the movement of the clutch yoke 35. As a result, the engagement between the pair of recesses 29a of the pinion gear 29 and the pair of protrusions 7a of the spool 7 shown in FIG. 1 is released.

In this state, the rotation of the handle 5 is not transmitted to the spool shaft 7, and the spool 9 can freely rotate. In this manner, the rotation transmission state of the handle 5 and the spool 9 is switched from the on state to the off state.

When the handle 5 and the handle shaft 25 are rotated, when the rotation transmission state of the spool 9 is in the off state, a return structure (not illustrated) rotates the clutch plate 31 and the clutch cam 33 in the second rotational direction R2. As a result, the clutch yoke 35 is biased by a coil spring (not illustrated) and moves in the axial direction approaching the first side plate 15a of the frame 15.

In this case, the pinion gear 29 moves in the axial direction approaching the spool 9, and the pair of recesses 29a of the pinion gear 29 shown in FIG. 1 engages with the pair of protrusions 7a of the spool shaft 7. In this state, the rotation of the handle 5 is transmitted to the spool shaft 7 via a drag mechanism (not illustrated). In this manner, the rotation transmission state of the handle 5 and the spool 9 is switched from the off state to the on state.

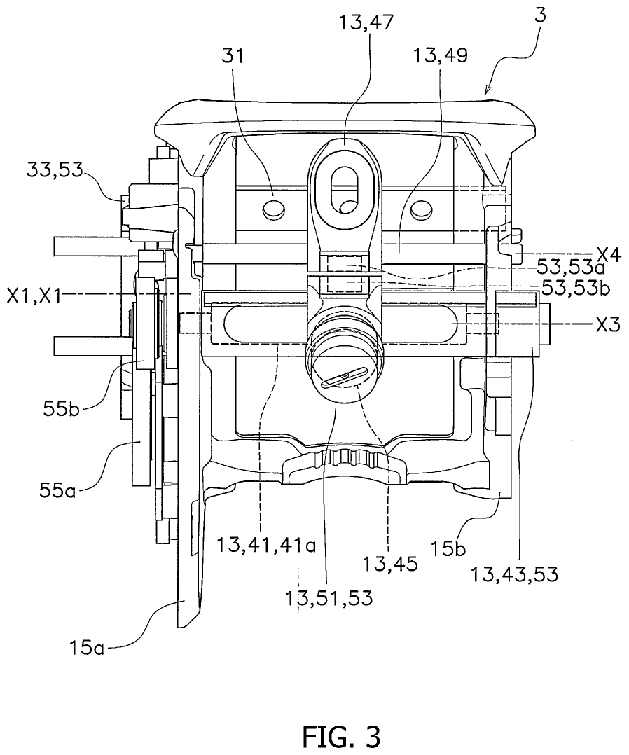

The level winding mechanism 13 shown in FIG. 3 is used for evenly winding the fishing line onto the spool 9. The level winding mechanism 13 comprises a worm shaft 41, a guide member 43, an engagement pawl 45 (one example of an engagement member), a line guide unit 47, a plurality of guide shafts 49, a moving part 51, and a switching mechanism 53.

The worm shaft 41 shown in FIGS. 2 and 3 rotates relative to the reel body 3 in conjunction with the rotation of the spool 9. The worm shaft 41 is disposed parallel to the spool shaft 7. A rotational axis X3 of the worm shaft 41 is parallel to the axis X1 of the spool shaft 7.

In the present embodiment, the direction in which the rotational axis X3 of the worm shaft 41 extends is referred to as the axial direction of the worm shaft 41. The axial direction of the worm shaft 41 is the same as the axial direction of the spool shaft 7. The direction around the rotational axis X3 of the worm shaft 41 is referred to as the circumferential direction of the worm shaft 41. The direction away from the rotational axis X3 of the worm shaft 41 is referred to as the radial direction of the worm shaft 41.

As shown in FIG. 3, the worm shaft 41 is disposed inside the guide member 43 and is supported so as to be rotatable relative to the guide member 43. The rotation of the handle 5 is transmitted to the worm shaft 41. One end of the worm shaft 41 is disposed between the first side cover 17 and the first side plate 15a. A spiral groove 41a is disposed on the outer circumferential surface of the worm shaft 41. In FIG. 3, the shape of the spiral groove 41a is shown in a simplified manner.

The rotation of the handle 5 is transmitted to the worm shaft 41 via a first gear 55a and a second gear 55b. The first gear 55a is provided on the handle shaft 25 so as to rotate integrally with the handle shaft 25. The first gear 55a meshes with the second gear 55b. As shown in FIG. 3, the second gear 55b is provided at one end of the worm shaft so as to rotate integrally with the worm shaft. When the handle shaft 25 rotates, the worm shaft rotates via the first gear 55a and the second gear 55b.

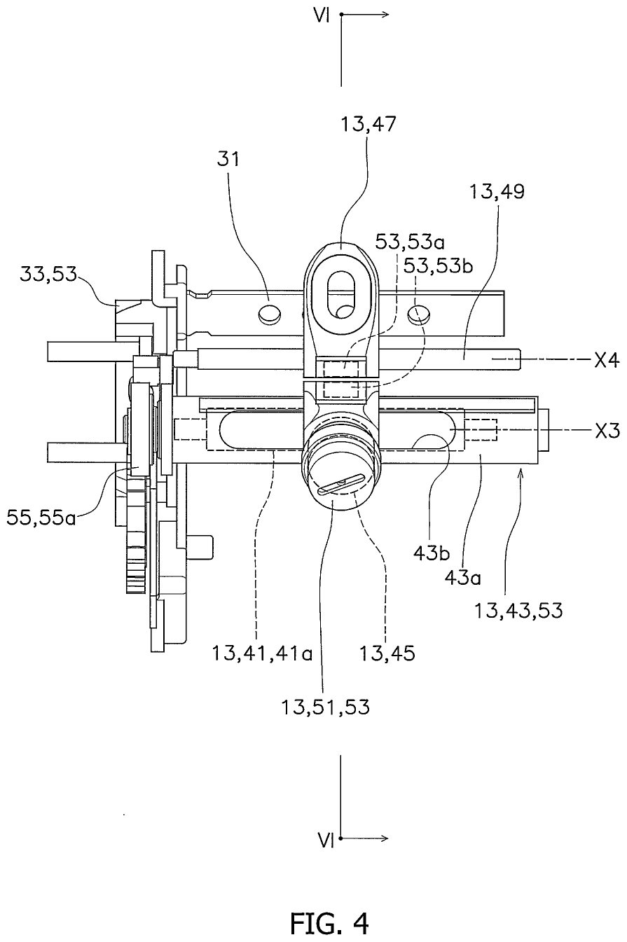

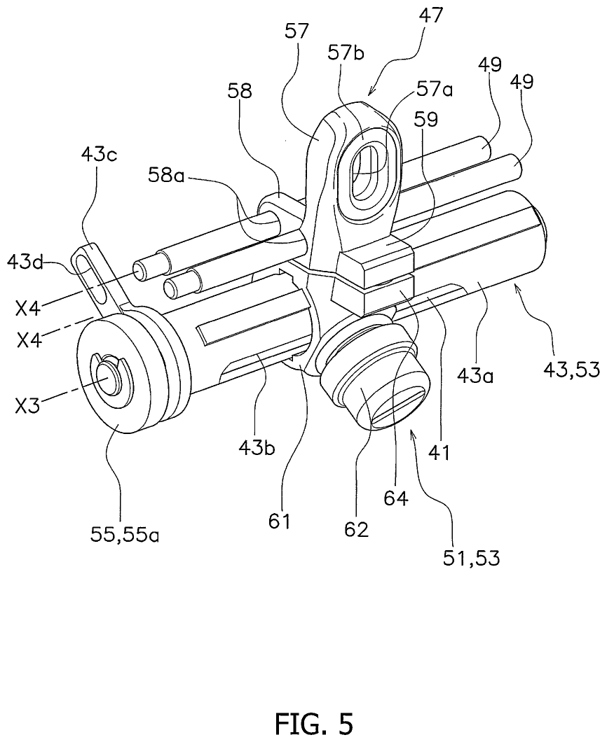

The guide member 43 shown in FIG. 3 is configured to guide the moving part 51 in the axial direction of the worm shaft 41 via the engagement pawl 45. As shown in FIGS. 4 and 5, the guide member 43 has a tubular portion 43a, a slit 43b, and the second arm portion 43c (refer to FIG. 2).

The tubular portion 43a is formed in a tubular shape. The tubular portion 43a is disposed radially outward of the worm shaft 41. The tubular portion 43a is supported so as to be rotatable with respect to the first side plate 15a of the frame 15 and the second side plate 15b of the frame 15. The slit 43b penetrates the tubular portion 43a and extends along the axial direction of the worm shaft 41.

As shown in FIG. 2, the second arm portion 43c extends rearward from the tubular portion 43a. Specifically, the second arm portion 43c extends toward the first arm portion 33b of the clutch cam 33. The second arm portion 43c includes the slot 43d. The protrusion 33c of the first arm portion 33b engages with the slot 43d.

As shown in FIGS. 3 and 4, the engagement pawl 45 is held by the moving part 51. The engagement pawl 45 is inserted in the slit 43b of the guide member 43 and engages the spiral groove 41a of the worm shaft 41.

The line guide unit 47 shown in FIG. 3 is configured to guide the fishing line. The line guide unit 47 is configured to move along the axial direction of the spool shaft 7. In other words, the line guide unit 47 is configured to move along the axial direction of the guide shaft 49.

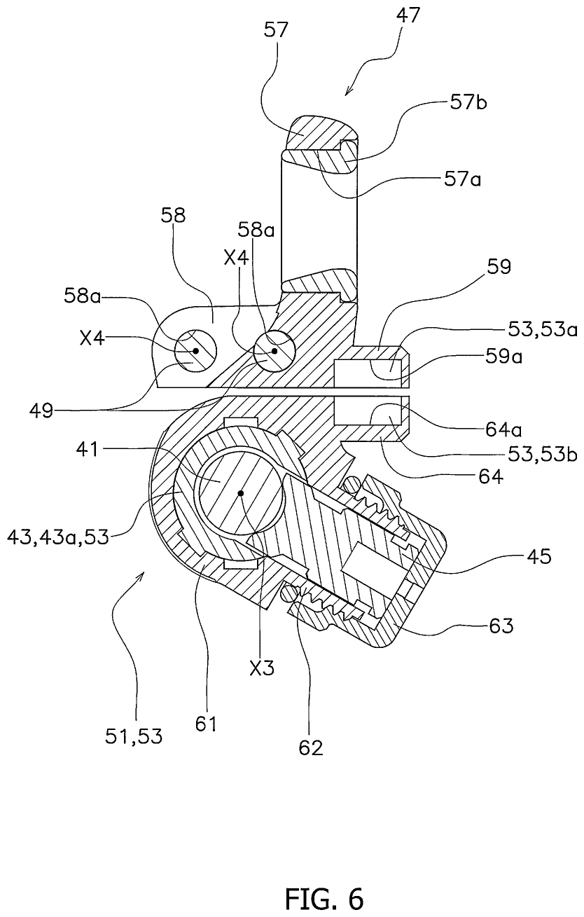

As shown in FIGS. 5 and 6, the line guide unit 47 has a body portion 57, a sliding portion 58, and a first holding portion 59. The body portion 57 includes a line-releasing hole 57a. The fishing line is inserted through the line-releasing hole 57a via a fishing line guide 57b. The sliding portion 58 is provided on the body portion 57. The sliding portion 58 slides along the plurality of guide shafts 49 via a plurality of hole portions 58a, for example, two hole portions 58a. The first holding portion 59 is provided on the body portion 57. As shown in FIG. 6, the first holding portion 59 is provided with a first recess 59a. A first magnet 53a of the switching mechanism 53, described further below, is disposed in the first recess 59a.

As shown in FIGS. 3-6, the plurality of guide shafts 49 are provided along the rotational axis X3 of the worm shaft 41. The plurality of guide shafts 49 guide the line guide unit 47 in the axial direction of the guide shafts 49. In the present embodiment, the direction in which a rotational axis X4 of the guide shaft 49 extends is referred to as the axial direction of the guide shaft 49. The axial direction of the guide shaft 49 is defined as the direction in which the rotational axis X4 of each of the plurality of guide shafts 49 extends. The axial direction of the guide shaft 49 is the same as the axial direction of the spool shaft 7. The rotational axis X4 of each of the plurality of guide shafts 49 is parallel to the axis X1 of the spool shaft 7.

In the present embodiment, having a plurality of guide shafts 49 includes having two guide shafts 49. The plurality of guide shafts 49 are arranged between the line guide unit 47 and the spool 9. The two ends of each of the plurality of guide shafts 49 are fixed between the first side plate 15a and the second side plate 15b. The plurality of guide shafts 49 are respectively inserted into the plurality of hole portions 58a, for example, into two hole portions 58a.

The moving part 51 shown in FIG. 3 moves along the axial direction of the spool shaft 7. The moving part 51 moves along the axial direction of the spool shaft 7 in conjunction with the rotation of the worm shaft 41, via the engagement pawl 45. In other words, the moving part 51 moves along the axial direction of the worm shaft 41 in conjunction with the rotation of the worm shaft 41, via the engagement pawl 45.

As shown in FIGS. 5 and 6, the moving part 51 has a mounting portion 61, a pawl holding portion 62, and a second holding portion 64. The mounting portion 61 is mounted on the tubular portion 43a of the guide member 43. The mounting portion 61 rotates integrally with the tubular portion 43a of the guide member 43. The mounting portion 61 moves in the axial direction of the worm shaft 41 along the tubular portion 43a of the guide member 43.

As shown in FIG. 6, the pawl holding portion 62 holds the engagement pawl 45. The pawl holding portion 62 is provided on the mounting portion 61. The pawl holding portion 62 is formed in a tubular shape and the opening thereof is covered with a cap 63. The engagement pawl 45 is disposed inside the pawl holding portion 62. The cap 63 may be interpreted as a component of the mounting portion 61. The second holding portion 64 is provided on the mounting portion 61. The second holding portion 64 includes a second recess 64a. A second magnet 53b of the switching mechanism 53, described further below, is disposed in the second recess 64a.

The switching mechanism 53 shown in FIGS. 2 and 3 switches between a coupled state in which the line guide unit 47 and the moving part 51 are coupled, and a decoupled state in which the line guide unit 47 and the moving part 51 are decoupled, in accordance with the switching between the on state and the off state. Specifically, the switching mechanism 53 rotates the guide member 43 and the moving part 51 in the circumferential direction of the worm shaft 41 to switch between the coupled state and the decoupled state.

As shown in FIGS. 2-3, 5, and 6, the switching mechanism 53 is composed of the clutch cam 33 (refer to FIG. 2), the guide member 43, the moving part 51, the first magnet 53a, and the second magnet 53b. The clutch cam 33, the guide member 43, and the moving part 51 are configured as described above.

As shown in FIGS. 3, 4, and 6, the first magnet 53a is provided in the line guide unit 47. As shown in FIG. 6, the first magnet 53a is installed in the first recess 59a of the line guide unit 47.

As shown in FIGS. 3, 4, and 6, the second magnet 53b is provided on the moving part 51. As shown in FIG. 6, the second magnet 53b is installed in the second recess 64a of the moving part 51. The second magnet 53b is a magnet that attracts, and is attracted to, the first magnet 53a due to magnetic force. The second magnet 53b is disposed facing the first magnet 53a, in a state in which the first holding portion 59 of the line guide unit 47 and the second holding portion 64 of the moving part 51 face each other.

In the present embodiment, both the first magnet 53a and the second magnet 53b are magnetic bodies that are magnetized. One of either the first magnet 53a or the second magnet 53b may be a magnetic body that has been magnetized, while the other element, i.e., the second magnet 53b or the first magnet 53a, may be a magnetic body that is not magnetized.

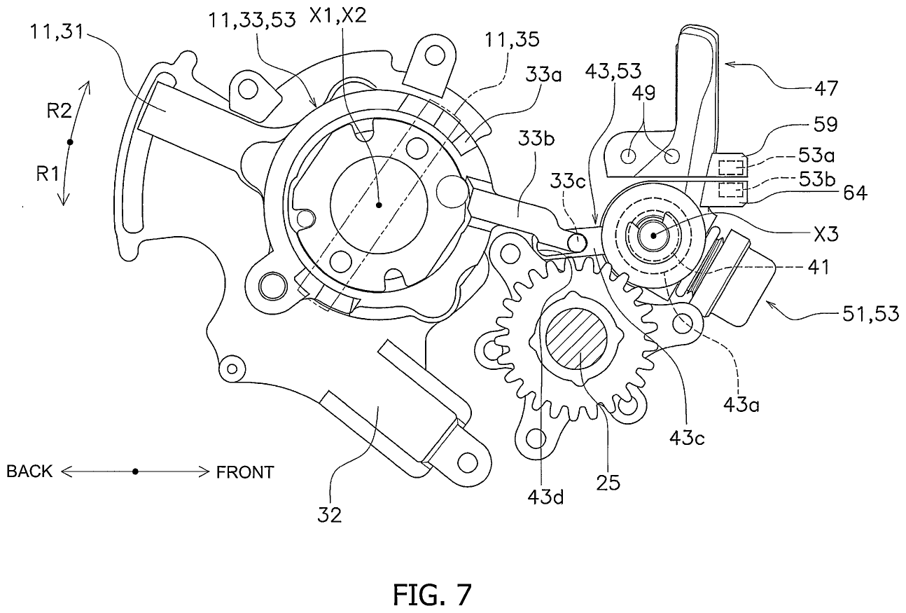

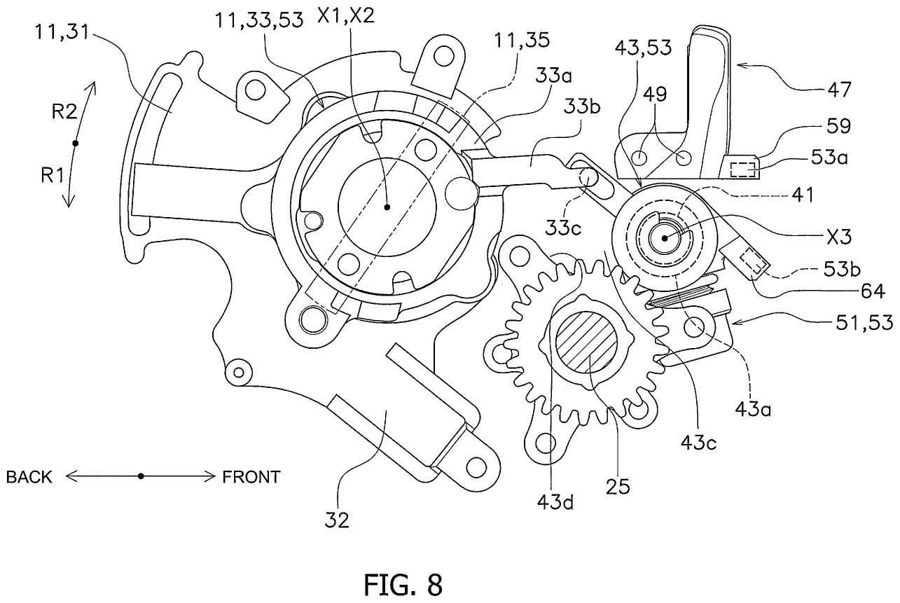

As shown in FIGS. 7 and 8, in the switching mechanism 53, the first arm portion 33b of the clutch cam 33 rotates in the first rotational direction R1 or the second rotational direction R2, when the clutch cam 33 turns in accordance with the rotating of the clutch plate 31. Since the protrusion 33c of the first arm is engaged with the slot 43d of the second arm portion 43c, the second arm portion 43c rotates in the circumferential direction of the worm shaft 41 in accordance with the rotating of the first arm portion 33b.

As a result, the guide member 43 and the moving part 51 turn in the circumferential direction of the worm shaft 41. As the guide member 43 and the moving part 51 turn, the state of the line guide unit 47 and the moving part 51 is switched from the coupled state to the decoupled state, or from the decoupled state to the coupled state.

FIG. 7 shows a case in which the line guide unit 47 and the moving part 51 are in the coupled state. In the coupled state, the second holding portion 64 of the moving part 51 is arranged facing the first holding portion 59 of the line guide unit 47. In this state, the second magnet 53b of the second holding portion 64 is arranged facing the first magnet 53a of the first holding portion 59, and the first magnet 53a and the second magnet 53b attract each other. In this case, the line guide unit 47 is guided to the guide shaft 49 in conjunction with the rotation of the worm shaft 41, and moves in the axial direction of the worm shaft 41 together with the moving part 51.

FIG. 8 shows a case in which the line guide unit 47 and the moving part 51 are in the decoupled state. In the decoupled state, the second holding portion 64 of the moving part 51 separates from the first holding portion 59 of the line guide unit 47. That is, the second magnet 53b of the second holding portion 64 separates from the first magnet 53a of the first holding portion 59. In this case, the line guide unit 47 moves freely along the guide shaft 49 in the axial direction of the guide shaft 49, independently of the moving part 51.

In the dual-bearing reel 1 having the configuration described above, when the rotation transmission state of the handle 5 and the spool 9 is in the on state (the case shown in FIG. 7), the line guide unit 47 and the moving part 51 are in the coupled state. When the handle 5 is rotated in this state, the worm shaft 41 rotates and the line guide unit 47 and the moving part 51 move in the axial direction of the worm shaft 41 along the worm shaft 41 and the tubular portion 43a of the guide member 43. As a result, the fishing line is evenly wound onto the spool 9.

When the rotation transmission state of the handle 5 and the spool 9 is in the on state (the case shown in FIG. 7) and the clutch lever 23 is pressed downward, the clutch plate 31 and the clutch cam 33 turn in the first rotational direction R1. The clutch yoke 35 and the pinion gear 29 move in the axial direction of the spool shaft 7 in accordance with the turning of the clutch cam 33. As a result, the rotation transmission state of the handle 5 and the spool 9 is switched from the on state to the off state. At this time, the guide member 43 and the moving part 51 turn in accordance with the turning of the clutch cam 33, and, as shown in FIG. 8, the state of the line guide unit 47 and the moving part 51 is switched from the coupled state to the decoupled state.

When the fishing line is released from the spool 9 in this decoupled state, the position from which the fishing line is released moves back and forth on the spool 9 in the axial direction of the spool shaft 7. The line guide unit 47 moves back and forth along the guide shaft 49 in the axial direction of the guide shaft 49, in accordance with the reciprocal movement of the position from which the fishing line is released. That is, at the time of line release, the line guide unit 47 moves back and forth along the guide shaft 49 in the axial direction of the guide shaft 49 such that the line guide unit 47 is positioned in front of the position from which the fishing line is released. As a result, it is possible to reduce the resistance that acts on the fishing line at the time of line release.

When the handle 5 is rotated in a state in which the rotation transmission state of the handle 5 and the spool 9 is in the off state and the line guide unit 47 and the moving part 51 are in the decoupled state, a return structure (not illustrated) returns the clutch lever 23 upward. As a result, the rotation transmission state of the handle 5 and the spool 9 returns to the on state, and the state of the line guide unit 47 and the moving part 51 returns to the coupled state.

When the rotation transmission state of the handle 5 and the spool 9 is in the on state and the line guide unit 47 and the moving part 51 are in the coupled state (the case shown in FIG. 7), in the case that the pull of the caught fish is strong, the fishing line is drawn out from the spool 9 due to slippage of the friction member of the drag mechanism.

Here, if the axial component of the force that acts on the line guide unit 47 from the fishing line is greater than the axial component of the force with which the first magnet 53a and the second magnet 53b attract each other, the engagement between the first magnet 53a and the second magnet 53b is released. Then, the line guide unit 47 moves in the direction of the axial component of the force that acts on the line guide unit 47 from the fishing line. As a result, the line guide unit 47 is positioned in front of the position on the spool 9 from which the fishing line is released. That is, the line guide unit 47 pays out the fishing line forward (i.e., the casting direction) while moving back and forth in the axial direction of the guide shaft 49. At this time, the moving part 51 is stationary in a state of being positioned on the worm shaft 41 by the engagement pawl 45.

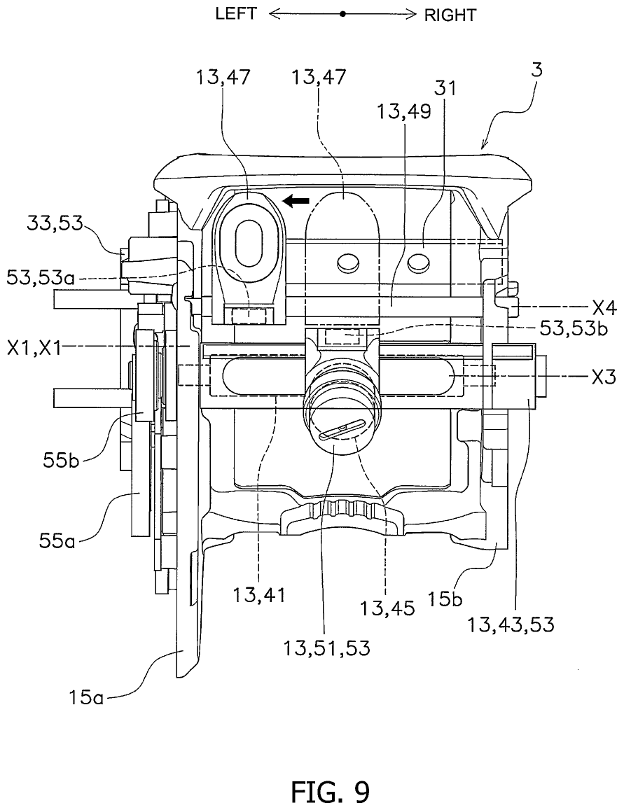

In this manner, when the fishing line is drawn out from the spool 9 due to slippage of the friction member of the drag mechanism, the line guide unit 47 moves along the guide shaft 49 relative to the moving part 51, as shown in FIG. 9. FIG. 9 shows an example in which the axial component of the force that acts on the line guide unit 47 from the fishing line is in the left direction. In this case, the line guide unit 47 moves in the left direction with respect to the moving part 51, in a state in which the moving part 51 is positioned on the worm shaft 41 by the engagement pawl 45.

A dual-bearing reel 1 having the configuration described above has the following features. In the dual-bearing reel 1, the switching mechanism 53 switches between the coupled state and the decoupled state in accordance with the switching between the on state and the off state. For example, when the rotation transmission state of the handle 5 and the spool 9 is in the on state, the switching mechanism 53 couples the line guide unit 47 and the moving part 51. The fishing line can be evenly wound onto the spool 9 by rotating the handle 5 in this state.

On the other hand, when the rotation transmission state of the handle 5 and the spool 9 is in the off state, the switching mechanism 53 decouples the line guide unit 47 and the moving part 51. When the fishing line is released in this state, the fishing line is guided forward by the line guide unit 47, while the line guide unit 47 moves along the axial direction of the spool shaft 7. In this manner, in this dual-bearing reel 1, it is possible to reduce the resistance that acts on the fishing line at the time of line release.

In the dual-bearing reel 1, when the rotation transmission state of the handle 5 and the spool 9 is in the on state, the switching mechanism 53 couples the line guide unit 47 and the moving part 51. By rotating the handle 5 in this state, the line guide unit 47 and the moving part 51 move along the axial direction of the spool shaft 7 in conjunction with the rotation of the worm shaft 41, via the engagement pawl 45. In this manner, the fishing line can be evenly wound onto the spool 9 even when using the switching mechanism 53.

In the dual-bearing reel 1, the moving part 51 can be rotated in the circumferential direction of the worm shaft 41 to easily switch the state of the line guide unit 47 and the moving part 51 between the coupled state and the decoupled state.

In the dual-bearing reel 1, it is possible to easily couple the moving part 51 with the line guide unit 47 using the magnetic force that acts between the first magnet 53a and the second magnet 53b, and to easily decouple the moving part 51 and the line guide unit 47.

In the dual-bearing reel 1, when the rotation transmission state of the spool 9 is in the on state and the line guide unit 47 and the moving part 51 are in the coupled state (the case shown in FIG. 7), in the case that the pull of the caught fish is strong and the friction member of the drag mechanism slips, the fishing line is released from the spool 9. In this case, the first magnet 53a and the second magnet 53b are disengaged, and the line guide unit 47 moves back and forth in the axial direction of the guide shaft 49 relative to the moving part 51. In this manner, even in a case in which the pull of the caught fish is strong and the fishing line is drawn out from the spool 9, it is possible to reduce the resistance that acts on the fishing line being drawn out from the spool 9 and to prevent occurrence of problems such as line breakage.

### MODIFIED EXAMPLES

Although an embodiment of the present disclosure has been presented heretofore, the present disclosure is not limited to these, and various modifications can be made without departing from the scope of the disclosure.

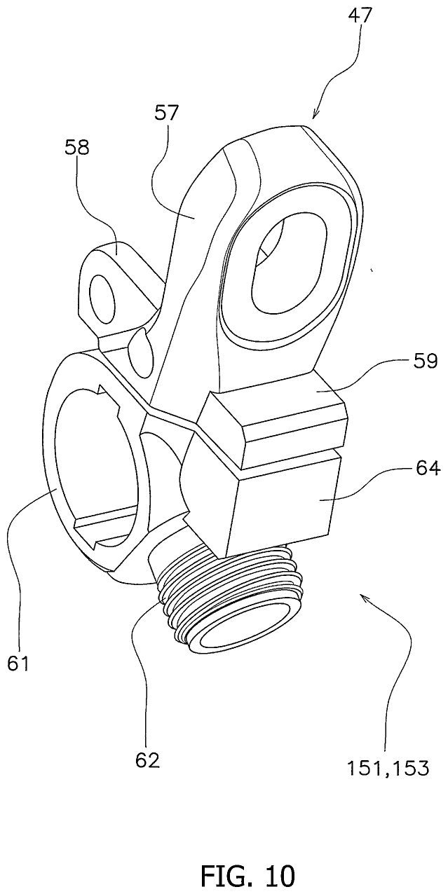

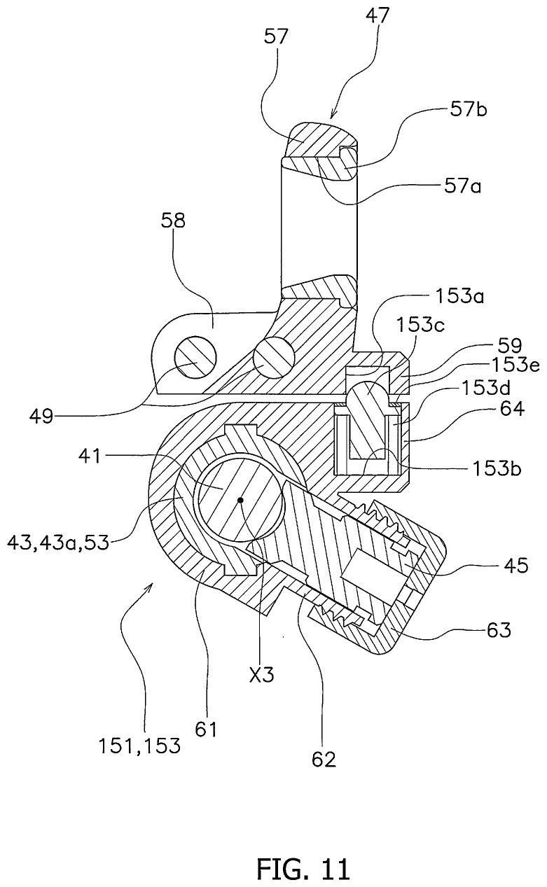

The switching mechanism 53 described above can be configured as shown in FIGS. 10 and 11. In FIGS. 10 and 11, configurations that are the same as those in the embodiment described above have been assigned the same reference numerals as in the embodiment. In this case, a switching mechanism 153 has an engagement recess 153a, a stowage recess 153b, and an engagement pin 153c. The engagement recess 153a is provided in the first holding portion 59 of the line guide unit 47. The stowage recess 153b is provided in the second holding portion 64 of the moving part 51.

As shown in FIG. 11, the engagement pin 153c is disposed in the second holding portion 64 of the moving part 51, for example, in the stowage recess 153b. A coil spring 153d is disposed between the bottom portion of the stowage recess 153b and the engagement pin 153c. The opening of the stowage recess 153b is covered by a lid member 153e so that the engagement pin 153c does not fly out of the stowage recess 153b. In this state, the coil spring 153d biases the engagement pin 153c.

As shown in FIG. 11, in the coupled state, the head of the engagement pin 153c engages the engagement recess 153a of the line guide unit 47. In the decoupled state, the engagement pin 153c of the moving part 51 separates from the engagement recess 153a of the line guide unit 47. The mode by which the state of the line guide unit 47 and the moving part 51 is switched between the coupled state and the decoupled state is the same as that in the embodiment described above. Even with this configuration, the same effect as the above-described embodiment can be obtained.

What is claimed is:

1. A dual-bearing reel, comprising
a reel body;
a handle configured to rotate relative to the reel body;
a spool shaft supported by the reel body so as to be rotatable;
a spool configured to rotate together with the spool shaft and around which a fishing line is capable of being wound;
a clutch mechanism configured to switch between an on state in which rotation of the handle is transmitted to the spool, and an off state in which the transmission of the rotation of the handle to the spool is not transmitted; and
a level winding mechanism configured to evenly wind the fishing line onto the spool,
the level winding mechanism including
a line guide unit configured to guide the fishing line and move along an axial direction of the spool shaft,
a moving part configured to move along the axial direction of the spool shaft, and
a switching mechanism configured to switch between a coupled state in which the line guide unit and the moving part are coupled, and a decoupled state in which the line guide unit and the moving part are decoupled, in accordance with the switching between the on state and the off state.

2. The dual-bearing reel according to claim 1, wherein
the level winding mechanism further includes a worm shaft having a spiral groove and configured to rotate relative to the reel body in conjunction with rotation of the spool, and an engagement member configured to engage the spiral groove, and
the moving part is configured to move along the axial direction of the spool shaft in conjunction with the rotation of the worm shaft, via the engagement member.

3. The dual-bearing reel according to claim 2, wherein
the level winding mechanism further includes a guide member configured to guide the moving part in the axial direction of the worm shaft, and rotate in a circumferential direction of the worm shaft together with the moving part, and
the switching mechanism is configured to rotate the guide member in the circumferential direction of the worm shaft to switch between the coupled state and the decoupled state.

4. The dual-bearing reel according to claim 1, wherein
the switching mechanism has a first magnet provided on one of the moving part or the line guide unit, and a magnetic body that is provided on the other of the line guide unit or the moving part, and the magnetic body facing the first magnet.

5. The dual-bearing reel according to claim 4, wherein
the magnetic body includes a second magnet configured to attract, and to be attracted to, the first magnet due to magnetic force.
